(19) United States
(12) Patent Application Publication
(10) Pub. No.: US 2025/0279016 A1
(43) Pub. Date: Sep. 4, 2025

(54) DISPLAY APPARATUS

(71) Applicant: LG ELECTRONICS INC., Seoul (KR)

(72) Inventors: Taeho KIM, Seoul (KR); Sungwhan LEE, Seoul (KR)

(73) Assignee: LG ELECTRONICS INC., Seoul (KR)

(21) Appl. No.: 18/689,288

(22) PCT Filed: Sep. 6, 2021
(86) PCT No.: PCT/KR2021/011983

§ 371 Date: Aug. 21, 2024

(51) Int. Cl. G09F 11/04; G09F 9/33; G09F 11/10; G09F 19/12

(52) U.S. Cl. CPC G09F 11/04; G09F 9/33; G09F 11/10; G09F 19/12

(57) ABSTRACT

A display apparatus is disclosed. The display apparatus according to an embodiment of the present disclosure includes: a case; a motor disposed in the case; a rotation plate rotated by the motor; a plurality of light source bars disposed on the rotation plate, and including a plurality of light sources vertically arranged; a fixed plate spaced below the rotation plate; a first and a second infrared (IR) output device disposed on the fixed plate; and a first and a second IR receiving device disposed on the rotation plate. Accordingly, a rotatable display apparatus, capable of reducing image blur during image display based on an afterimage, may be implemented.

### BACKGROUND

### 1. Technical Field

The present disclosure relates to a display apparatus, and more particularly to a rotatable display apparatus capable of reducing image blur during image display based on an afterimage.

### 2. Description of the Related Art

A display apparatus is an apparatus for displaying images through a display.

Recently, research is conducted on commercial display apparatuses for various commercial purposes.

For example, a rotatable display apparatus using an afterimage is being developed.

However, when implementing the rotatable display apparatus using an afterimage, image blur becomes severe during image display due to a change in rotational speed of a motor, thereby causing problems in that visibility of an image decreases, and image quality is reduced.

### SUMMARY

It is an objective of the present disclosure to provide a rotatable display apparatus capable of reducing image blur during image display based on an afterimage.

It is another objective of the present disclosure to provide a rotatable display apparatus in which points represented by the respective pixels in an image are not blurred during image display based on afterimage.

In order to achieve the above objectives, a display apparatus according to an embodiment of the present disclosure includes: a case; a motor disposed in the case; a rotation plate rotated by the motor; a plurality of light source bars disposed on the rotation plate, and including a plurality of light sources vertically arranged; a fixed plate spaced below the rotation plate; a first infrared (IR) output device and a second IR output device disposed on the fixed plate and spaced apart from each other; and a first IR receiving device and a second IR receiving device disposed on the rotation plate and configured to receive infrared (IR) signals respectively output from the first IR output device and the second IR output device.

Meanwhile, the display apparatus according to an embodiment of the present disclosure may further include a processor configured to detect a change in rotational speed of the motor based on the IR signals received by the first IR receiving device and the second IR output device, and in response to the change in rotational speed of the motor, configured to change a turn-on period of the plurality of light sources.

Meanwhile, in response to detecting the change in rotational speed of the motor while displaying a first image frame, the processor may be configured to change the turn-on period of the plurality of light sources based on the change in rotational speed of the motor while displaying a second image frame after the first image frame.

Meanwhile, in response to an increase in rotational speed of the motor, the processor may be configured to decrease the turn-on period of the plurality of light sources, and in response to a decrease in rotational speed of the motor, the processor may be configured to increase the turn-on period of the plurality of light sources.

Meanwhile, the display apparatus according to an embodiment of the present disclosure may further include a processor configured to generate a pixel location signal and a start signal of an image frame based on the IR signals received by the first IR receiving device and the second IR output device.

Meanwhile, the display apparatus according to an embodiment of the present disclosure may further include a processor configured to display an image frame, including a pixel signal, based on the IR signals received by the first IR receiving device and the second IR output device.

Meanwhile, the plurality of light source bars may be equally spaced apart from a center of the rotation plate having a circular shape.

The plurality of light source bars may be equally spaced apart from the center of the rotation plate having a circular shape, wherein the first IR receiving device and the second IR receiving device may be disposed between a first light source bar, among the plurality of light source bars, and the center of the rotation plate.

Meanwhile, a plurality of first IR receiving devices may be disposed on the rotation plate, wherein the plurality of first IR receiving devices may be equally spaced apart from the center of the rotation plate having a circular shape.

Meanwhile, a plurality of first IR receiving devices may be disposed on the rotation plate, wherein the plurality of first IR receiving devices may be configured to receive the IR signal output from the first IR output device.

Meanwhile, a plurality of first IR output devices may be disposed on the fixed plate, wherein the plurality of first IR output devices may be equally spaced apart from a center of the fixed plate having a circular shape.

Meanwhile, a plurality of first IR output devices may be disposed on the fixed plate, wherein IR signals respectively output from the plurality of first IR output devices may be received by the first IR receiving device.

Meanwhile, the display apparatus according to an embodiment of the present disclosure may further include a processor configured to measure a change in speed of the motor based on the IR signals received by the first IR receiving device and the second IR receiving device during a first image frame period, and to display an image, corresponding to the measured change in speed of the motor, during a second image frame period after the first image frame period.

Meanwhile, the display apparatus according to an embodiment of the present disclosure may further include a processor configured to predict a maximum speed error during rotation of the motor based on the IR signals received by the first IR receiving device and the second IR receiving device, wherein a number of the first IR receiving devices may be determined based on the maximum speed error.

Meanwhile, a case, which is a portion of the case corresponding to an upper portion of the rotation plate, may include a transparent material.

Meanwhile, a case, which is a portion of the case corresponding to a lower portion of the rotation plate, may include an opaque material.

### Effect of the Disclosure

A display apparatus according to an embodiment of the present disclosure includes: a case; a motor disposed in the case; a rotation plate rotated by the motor; a plurality of light source bars disposed on the rotation plate, and including a plurality of light sources vertically arranged; a fixed plate spaced below the rotation plate; a first infrared (IR) output device and a second IR output device disposed on the fixed plate and spaced apart from each other; and a first IR receiving device and a second IR receiving device disposed on the rotation plate and configured to receive infrared (IR) signals respectively output from the first IR output device and the second IR output device. Accordingly, a rotatable display apparatus, capable of reducing image blur during image display based on an afterimage, may be implemented. Further, points represented by the respective pixels in an image are not blurred during image display based on an afterimage.

Meanwhile, the display apparatus according to an embodiment of the present disclosure may further include a processor configured to detect a change in rotational speed of the motor based on the IR signals received by the first IR receiving device and the second IR output device, and in response to the change in rotational speed of the motor, configured to change a turn-on period of the plurality of light sources. Accordingly, a rotatable display apparatus, capable of reducing image blur caused by a change in speed of the motor during image display based on an afterimage, may be implemented.

Meanwhile, in response to detecting the change in rotational speed of the motor while displaying a first image frame, the processor may be configured to change the turn-on period of the plurality of light sources based on the change in rotational speed of the motor while displaying a second image frame after the first image frame. Accordingly, a rotatable display apparatus, capable of reducing image blur caused by a change in speed of the motor during image display based on an afterimage, may be implemented.

Meanwhile, in response to an increase in rotational speed of the motor, the processor may be configured to decrease the turn-on period of the plurality of light sources, and in response to a decrease in rotational speed of the motor, the processor may be configured to increase the turn-on period of the plurality of light sources. Accordingly, a rotatable display apparatus, capable of reducing image blur caused by a change in speed of the motor during image display based on an afterimage, may be implemented.

Meanwhile, the display apparatus according to an embodiment of the present disclosure may further include a processor configured to generate a pixel location signal and a start signal of an image frame based on the IR signals received by the first IR receiving device and the second IR output device. Accordingly, a rotatable display apparatus may be implemented in which points represented by the respective pixels in an image are not blurred during image display based on an afterimage.

Meanwhile, the display apparatus according to an embodiment of the present disclosure may further include a processor configured to display an image frame, including a pixel signal, based on the IR signals received by the first IR receiving device and the second IR output device. Accordingly, a rotatable display apparatus, capable of reducing image blur during image display based on an afterimage, may be implemented.

Meanwhile, the plurality of light source bars may be equally spaced apart from a center of the rotation plate having a circular shape. Accordingly, a rotatable display apparatus, capable of reducing image blur by using the plurality of light source bars, may be implemented.

The plurality of light source bars may be equally spaced apart from the center of the rotation plate having a circular shape, wherein the first IR receiving device and the second IR receiving device may be disposed between a first light source bar, among the plurality of light source bars, and the center of the rotation plate. Accordingly, it is possible to separately receive an IR signal for fixing a screen position and an IR signal for indicating the start of an image.

Meanwhile, a plurality of first IR receiving devices may be disposed on the rotation plate, wherein the plurality of first IR receiving devices may be equally spaced apart from the center of the rotation plate having a circular shape. Accordingly, the IR signal for fixing a screen position may be identified frequently.

Meanwhile, a plurality of first IR receiving devices may be disposed on the rotation plate, wherein the plurality of first IR receiving devices may be configured to receive the IR signal output from the first IR output device. Accordingly, the IR signal for fixing a screen position may be identified frequently.

Meanwhile, plurality of first IR output devices may be disposed on the fixed plate, wherein the plurality of first IR output devices may be equally spaced apart from a center of the fixed plate having a circular shape.

Meanwhile, a plurality of first IR output devices may be disposed on the fixed plate, wherein IR signals respectively output from the plurality of first IR output devices may be received by the first IR receiving device. Accordingly, the IR signal for fixing a screen position may be identified frequently.

Meanwhile, the display apparatus according to an embodiment of the present disclosure may further include a processor configured to measure a change in speed of the motor based on the IR signals received by the first IR receiving device and the second IR receiving device during a first image frame period, and to display an image, corresponding to the measured change in speed of the motor, during a second image frame period after the first image frame period. Accordingly, a rotatable display apparatus, capable of reducing image blur caused by a change in speed of the motor during image display based on an afterimage, may be implemented.

Meanwhile, the display apparatus according to an embodiment of the present disclosure may further include a processor configured to predict a maximum speed error during rotation of the motor based on the IR signals received by the first IR receiving device and the second IR receiving device, wherein a number of the first IR receiving devices may be determined based on the maximum speed error.

Accordingly, a rotatable display apparatus, capable of reducing image blur caused by a change in speed of the motor during image display based on an afterimage, may be implemented. Particularly, a rotatable display apparatus may be implemented using an optimal number of first IR receiving devices.

Meanwhile, a case, which is a portion of the case corresponding to an upper portion of the rotation plate, may include a transparent material. Accordingly, an image may be displayed only in a region where the plurality of light sources are disposed.

Meanwhile, a case, which is a portion of the case corresponding to a lower portion of the rotation plate, may include an opaque material. Accordingly, an image is not displayed in a region where the plurality of light sources are not disposed.

### BRIEF DESCRIPTION OF THE DRAWINGS

FIGS. 1A and 1B are diagrams illustrating a display apparatus associated with the present disclosure.

FIGS. 2A and 2B are diagrams illustrating a display apparatus according to an embodiment of the present disclosure.

FIGS. 3A to 3C are diagrams illustrating a display apparatus according to another embodiment of the present disclosure.

FIGS. 4A and 4B are diagrams illustrating display apparatus according to yet another embodiment of the present disclosure.

FIG. 5 is an exemplary internal block diagram of the display apparatus of FIG. 3A.

FIGS. 6A and 7F are diagrams referred to in the description of the display apparatuses of FIGS. 2A to 5.

### DETAILED DESCRIPTION

Hereinafter, the present disclosure will be described in detail with reference to the accompanying drawings. In order to clearly and briefly describe the present disclosure, components that are irrelevant to the description will be omitted in the drawings. The same reference numerals are used throughout the drawings to designate the same or similar components, and a redundant description thereof will be omitted.

It should be understood that the terms “comprise”, ‘include”, “have”, etc. when used in this specification, specify the presence of stated features, integers, steps, operations, elements, components, or combinations of them but do not preclude the presence or addition of one or more other features, integers, steps, operations, elements, components, or combinations thereof.

It will be understood that, although the terms first, second, etc., may be used herein to describe various elements, these elements should not be limited by these terms. These terms are only used to distinguish one element from another.

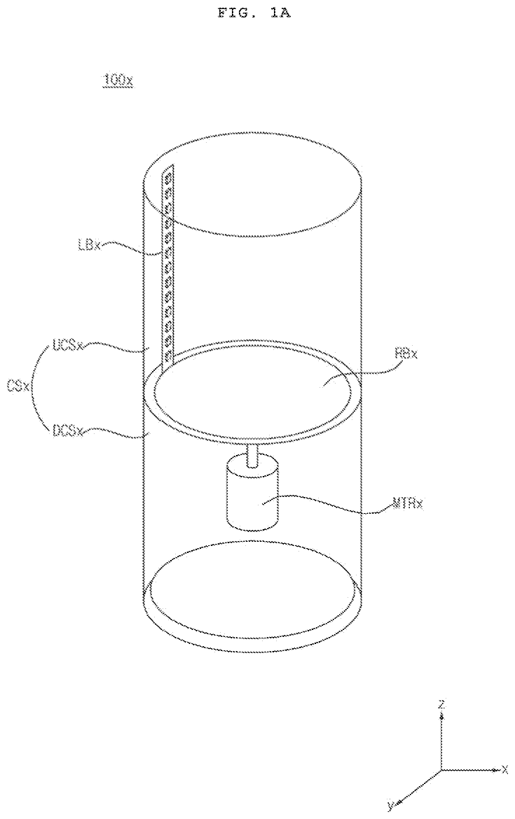

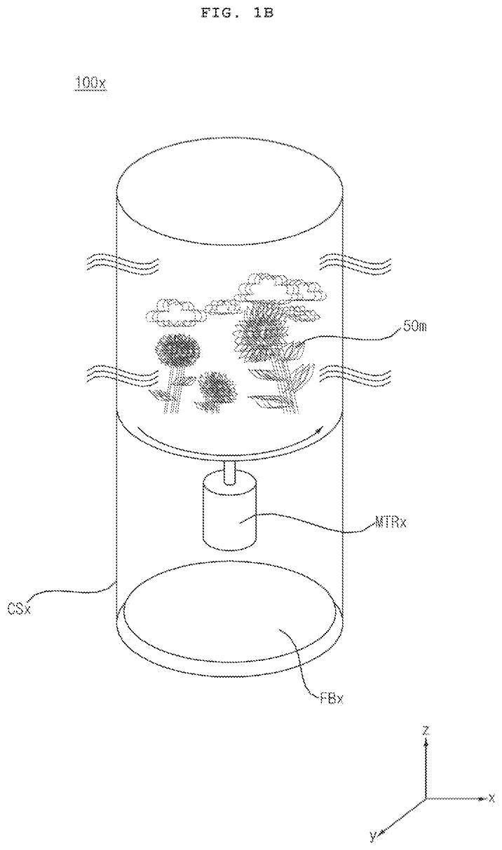

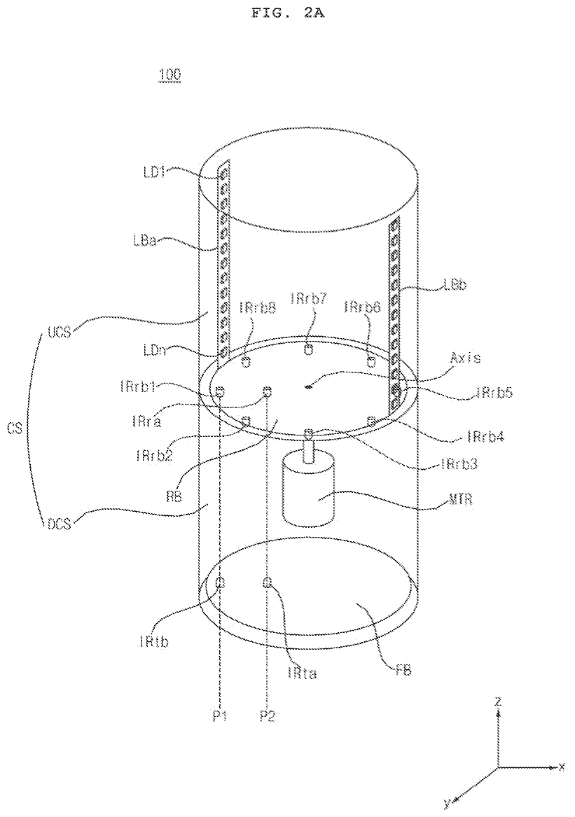

FIGS. 1A and 1B are diagrams illustrating a display apparatus associated with the present disclosure.

FIG. 1A is a diagram illustrating an outer appearance of a display apparatus 100x associated with the present disclosure, and FIG. 1B is a diagram illustrating an image displayed on the display apparatus 100x of FIG. 1A.

Referring to the drawings, the display apparatus 100x associated with the present disclosure includes a case CSx, a motor MTRx disposed in the case CSx, a rotation plate RBx rotated by the motor MTRx, and a light source bar LBx disposed on the rotation plate RBx.

The light source bar LBx may include a plurality of light sources configured to output a plurality of lights, and may output light in the positive or negative x-direction.

For example, when the motor MTRx rotates in a counterclockwise direction, the rotation plate RBx and the light source bar LBx on the rotation plate RBx rotate in the counterclockwise direction to output light.

Further, by an afterimage effect based on the output light, a predetermined image is perceived from the outside as being displayed.

Meanwhile, as illustrated herein, in the case where light is output using the one light source bar LBx, the one light source bar LBx is required to cover the whole one rotation, such that the motor MTRx is required to rotate at a high speed.

For example, in order to display an image at 60 Hz, the rotational speed of the motor MTRx should correspond to 60 Hz.

Meanwhile, as the rotational speed of the motor MTRx increases, vibration and noise increase due to the rotation of the motor MTRx. Accordingly, it is desirable to appropriately reduce the rotational speed of the motor MTRx.

Meanwhile, during rotation of the motor MTRx, load of the motor MTRx or performance of the motor MTRx, or other external factors make it difficult to maintain the motor MTRx at a constant rotational speed, thereby resulting in an increase in periods of non-constant rotational speed during one rotation of the motor MTRx.

That is, despite an attempt to drive the motor MTRx at a constant rotational speed, the rotational speed of the motor MTRx increases.

If the rotational speed of the motor MTRx changes, blur occurs in a displayed image.

That is, as illustrated in FIG. 1B, severe blur occurs in an image 50m displayed on the display 100x. Accordingly, visibility of the image 50m decreases.

The blur of the image 50m is more severe than the case where there is one light source bar LBx.

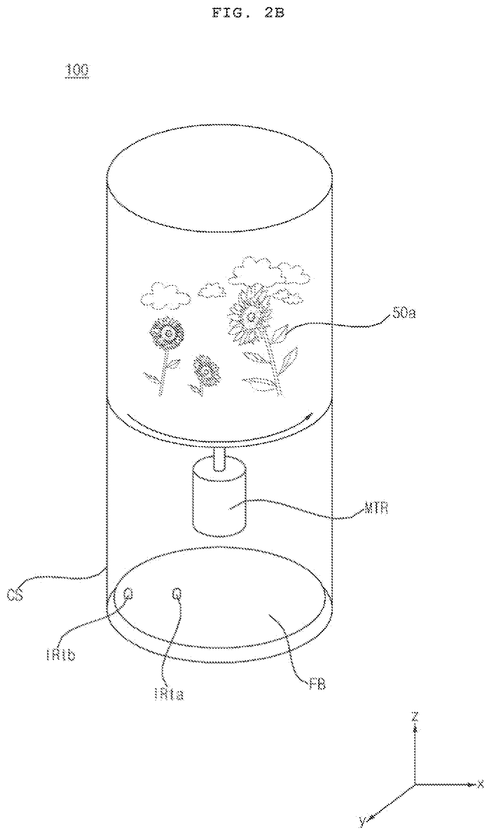

Accordingly, embodiments of the present disclosure propose a rotatable display apparatus 100 capable of reducing image blur during image display based on an afterimage, which will be described below with reference to FIG. 2A and subsequent figures.

FIGS. 2A and 2B are diagrams illustrating a display apparatus according to an embodiment of the present disclosure.

FIG. 2A is a diagram illustrating an outer appearance of a display apparatus 100 according to an embodiment of the present disclosure, and FIG. 2B is a diagram illustrating an image displayed on the display 100 of FIG. 2A.

Referring to the drawings, the display apparatus 100 according to an embodiment of the present disclosure may include a case CS, a motor MTR disposed in the case CS, a rotation plate RB rotated by the motor MTR, a plurality of light source bars LBa and LBb disposed on the rotation plate RB and including a plurality of light sources LD1 to LDn that are vertically arranged, and a fixed plate FB spaced below the rotation plate RB.

Meanwhile, the display apparatus 100 according to an embodiment of the present disclosure includes a first infrared (IR) output device IRtb and a second IR output device IRta which are disposed on the fixed plate FB and are spaced apart from each other, and a first IR receiving device IRrb1 and a second IR receiving device IRra which are disposed on the rotation plate RB and are configured to receive an infrared signal output from each of the first IR output device IRtb and the second IR output device IRta.

The first IR output device IRtb may output an IR signal for fixing a screen position, and the first IR receiving device IRrb1 may receive the IR signal output from the first IR output device IRtb.

The second IR output device IRta outputs an IR signal for indicating a start position of an image, and the second IR receiving device IRra may receive the IR signal output from the second IR output device IRta.

Accordingly, it is possible to identify the start position of an image and to fix the screen position. Accordingly, the display apparatus 100, capable of reducing image blur during image display based on an afterimage, may be implemented. In addition, the display apparatus 100 may be implemented in which points represented by the respective pixels in an image are not blurred during image display based on an afterimage.

The plurality of light source bars LBa and LBb may include a plurality of light sources configured to output a plurality of lights, and may output light in the positive or negative x-direction.

For example, the plurality of light sources LD1 to LDn may include light emitting diodes (LED) and may output light in the positive or negative x-direction.

Meanwhile, the plurality of light source bars LBa and LBb, which are disposed on the rotation plate RB, rotate together during rotation of the rotation plate RB.

In the drawing, an example is illustrated in which the plurality of light source bars LBa and LBb are disposed at an end portion of the rotation plate RB, but unlike the drawing, the plurality of light source bars LBa and LBb may also be disposed in a middle region of the rotation plate RB.

Meanwhile, the rotation plate RB rotates together by rotation of the motor MTR.

For example, when the motor MTR rotates in a counterclockwise direction, the rotation plate RB and the light source bars LBa and LBb on the rotation plate RB rotate in the counterclockwise direction to output light.

Further, by an afterimage effect based on the output light, a predetermined image is perceived from the outside as being displayed.

Meanwhile, as illustrated herein, by outputting light using the plurality of light source bars LBa and LBb, rotation at a high speed is not required compared to the one light source bar LBx of FIG. 1A.

Specifically, as the number of the plurality of light source bars LBa and LBb increases, the rotational speed of the motor MTR may decrease.

For example, as illustrated in FIG. 2A, if the number of the plurality of light source bars LBa and LBb is two, the rotational speed of the motor MTR is preferably 30 Hz for displaying an image at 60 Hz. Compared to FIG. 1A, the rotational speed of the motor MTR is reduced to half (½).

In another example, if the number of the plurality of light source bars is four, the rotational speed of the motor MTR is preferably 15 Hz for displaying an image at 60 Hz. Compared to FIG. 1A, the rotational speed of the motor MTR is reduced to one-quarter (¼).

In yet another example, if the number of the plurality of light source bars is 10, the rotational speed of the motor MTR is preferably 6 Hz for displaying an image at 60 Hz. Compared to FIG. 1A, the rotational speed of the motor MTR is reduced to one-tenth ( 1/10).

Meanwhile, as the rotational speed of the motor MTR is reduced compared to FIG. 1A, vibration and noise due to rotation when the motor MTR rotates may be reduced.

Meanwhile, if there is a period of non-constant rotational speed during one rotation of the motor MTR, the turn-on period of the plurality of light sources LD1 to LDn may be controlled in consideration of a change in speed of the motor MTR by using the first IR output device IRtb, the second IR output device IRta, the first IR receiving device IRrb1, the second IR receiving device IRra, unlike FIG. 1A.

Accordingly, even if there is a period of non-constant rotational speed during one rotation of the motor MTR, blurring of the image displayed on the display apparatus 100 may be reduced.

That is, as illustrated in FIG. 2B, an image 50 with reduced blur may be displayed through the display apparatus 100.

Meanwhile, FIG. 2A illustrates an example in which a plurality of first IR receiving devices are used.

Referring to the drawing, a plurality of first IR receiving devices IRrb1 to IRrb8 may be disposed on the rotation plate RB.

Meanwhile, the plurality of first IR receiving devices IRrb1 to IRrb8 may receive the IR signal output from the first IR output device IRtb.

In the drawing, an example is illustrated in which the number of the first IR receiving devices IRrb1 to IRrb8 is eight, but is not limited thereto.

For example, IRrb1 may be disposed at a position corresponding to 0/8 of rotation of the motor MTR to receive the IR signal, IRrb2 may be disposed at a position corresponding to ⅛ of rotation of the motor MTR to receive the IR signal, and IRrb8 may be disposed at a position corresponding to ⅞ of rotation of the motor MTR to receive the IR signal.

Accordingly, the IR signal for fixing a screen position may be identified frequently.

Meanwhile, as the number of the first IR receiving devices IRrb1 to IRrb8 increases, a screen position during one rotation of the motor MTR may be identified with more detailed resolution.

Meanwhile, a case UCS, which is a portion of the case CS corresponding to an upper portion of the rotation plate RB, may include a transparent material. Accordingly, an image may be displayed only in a region where the plurality of light sources LD1 to LDn are disposed.

Meanwhile, a case DCS, which is a portion of the case CS corresponding to a lower portion of the rotation plate RB, may include an opaque material. Accordingly, an image is not displayed in a region where the plurality of light sources LD1 to LDn are not disposed.

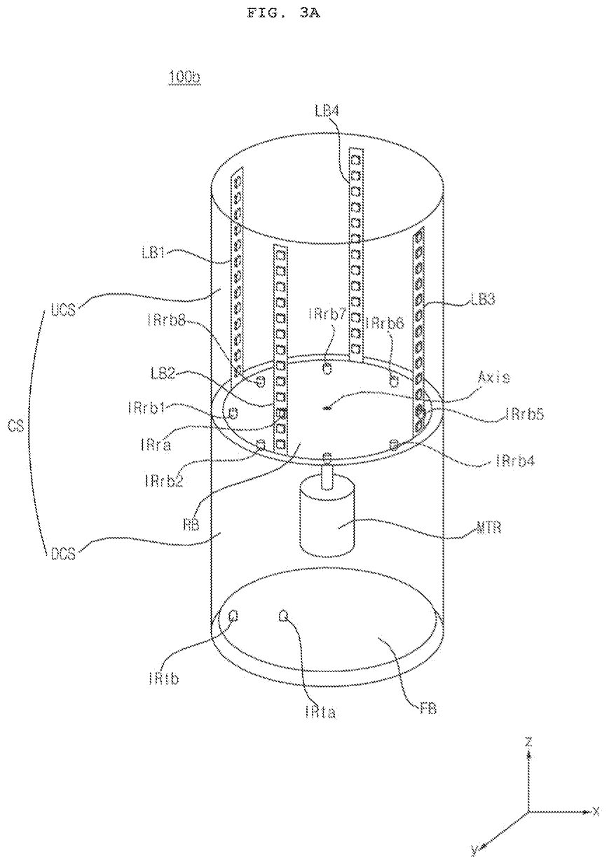

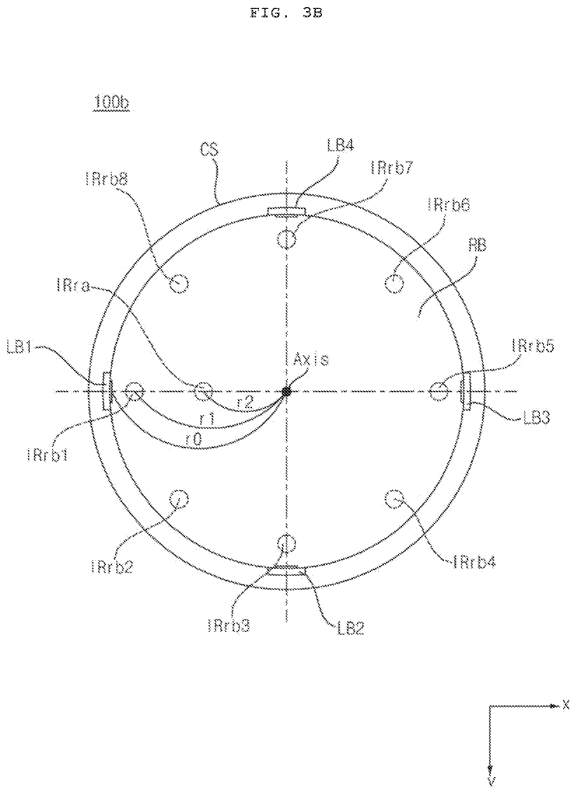

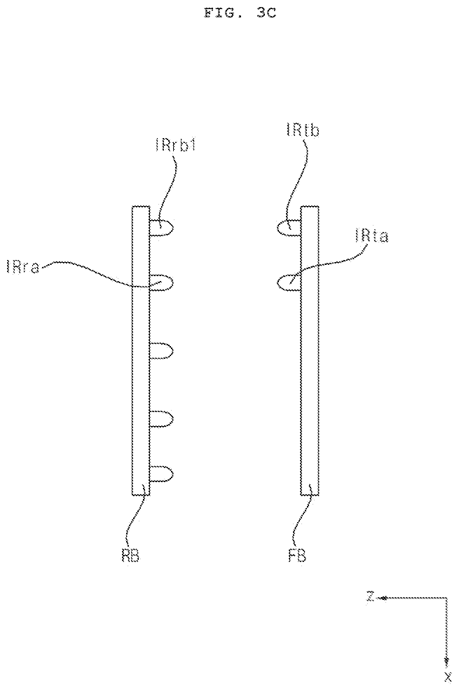

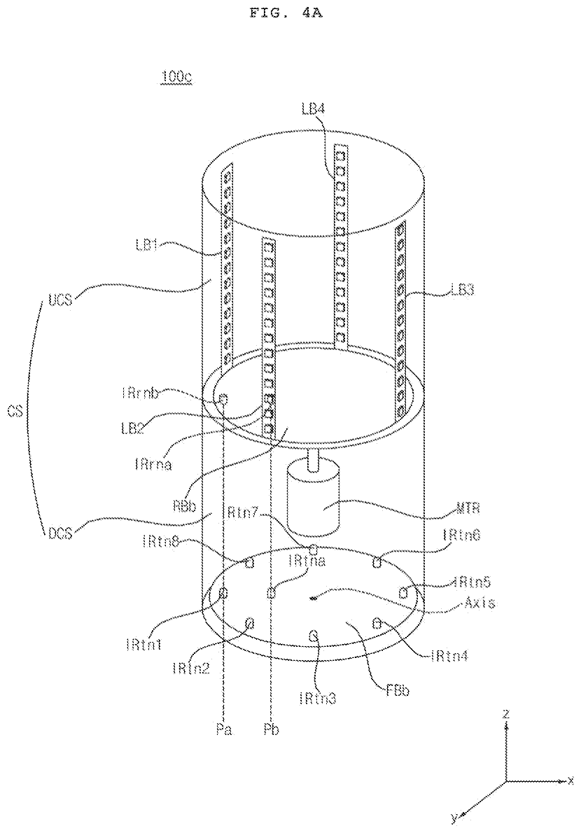

FIGS. 3A to 3C are diagrams illustrating a display apparatus according to another embodiment of the present disclosure.

FIG. 3A is a diagram illustrating an outer appearance of a display apparatus 100b according to another embodiment of the present disclosure, FIG. 3B is an exemplary cross-sectional view of the rotation plate RB of FIG. 3A, and FIG. 3C is an exemplary side view of the rotation plate RB and the fixed plate FB of FIG. 3A.

Referring to the drawings, the display apparatus 100b according to another embodiment of the present disclosure includes a case CS, a motor MTR disposed in the case CS, a rotation plate RB rotated by the motor MTR, a plurality of light source bars LB1 to LB4 disposed on the rotation plate RB and including a plurality of light sources LD1 to LDn that are vertically arranged, and a fixed plate FB spaced below the rotation plate RB.

The display apparatus 100 of FIG. 2A, in which the number of the plurality of light source bars is two, is different from the display apparatus 100b of FIG. 3A in which the number of the plurality of light source bars is four.

Meanwhile, the display apparatus 100b another embodiment of the according to present disclosure includes a first IR output device IRtb and a second IR output device IRta which are disposed on the fixed plate FB and are spaced apart from each other, and a first IR receiving device IRrb1 and a second IR receiving device IRra which are disposed on the rotation plate RB and are configured to receive an infrared signal output from each of the first IR output device IRtb and the second IR output device IRta.

The first IR output device IRtb may output an IR signal for fixing a screen position, and the first IR receiving device IRrb1 may receive the IR signal output from the first IR output device IRtb.

The second IR output device IRta outputs an IR signal for indicating a start position of an image, and the second IR receiving device IRra may receive the IR signal output from the second IR output device IRta.

Accordingly, it is possible to identify the start position of an image and to fix the screen position. Accordingly, the display apparatus 100, capable of reducing image blur during image display based on an afterimage, may be implemented. In addition, the display apparatus 100 may be implemented in which points represented by the respective pixels in an image are not blurred during image display based on an afterimage.

In the drawing, an example is illustrated in which the plurality of light source bars LB1 to LB4 are disposed at an end portion of the rotation plate RB, but unlike the drawing, the plurality of light source bars LB1 to LB4 may also be disposed in a middle region of the rotation plate RB.

Meanwhile, the rotation plate RB rotates together by rotation of the motor MTR.

For example, when the motor MTR rotates in a counterclockwise direction, the rotation plate RB and the light source bars LB1 to LB4 on the rotation plate RB rotate in the counterclockwise direction to output light.

Further, by an afterimage effect based on the output light, a predetermined image is perceived from the outside as being displayed.

Meanwhile, as illustrated herein, by outputting light using the plurality of light source bars LB1 to LB4, rotation at a high speed is not required compared to the one light source bar LBx of FIG. 1A.

For example, if the number of the plurality of light source bars is four as illustrated in FIG. 3A, the rotational speed of the motor MTR is preferably 15 Hz for displaying an image at 60 Hz. Compared to FIG. 1A, the rotational speed of the motor MTR is reduced to one-quarter (¼).

Meanwhile, as the rotational speed of the motor MTR is reduced compared to FIG. 1A, vibration and noise due to rotation when the motor MTR rotates may be reduced.

Meanwhile, if there is a period of non-constant rotational speed during one rotation of the motor MTR, the turn-on period of the plurality of light sources LD1 to LDn may be controlled in consideration of a change in speed of the motor MTR by using the first IR output device IRtb, the second IR output device IRta, the first IR receiving device IRrb1, and the second IR receiving device IRra, unlike FIG. 1A.

Accordingly, even if there is a period of non-constant rotational speed during one rotation of the motor MTR, blurring of the image displayed on the display apparatus 100 may be reduced.

Meanwhile, FIG. 3B illustrates an example in which a plurality of first IR receiving devices are used.

Referring to the drawing, a plurality of first IR receiving devices IRrb1 to IRrb8 may be disposed on the rotation plate RB.

Meanwhile, the plurality of first IR receiving devices IRrb1 to IRrb8 may receive the IR signal output from the first IR output device IRtb.

Meanwhile, the plurality of light source bars LB1 to LB4 may be equally spaced apart from a center Axis of the rotation plate RB having a circular shape.

Meanwhile, FIG. 3B illustrates an example in which the plurality of light source bars LB1 to LB4 are spaced apart from the center Axis of the circular rotation plate RB by a distance ro which is a radial distance of the circular rotation plate RB.

Accordingly, the rotatable display apparatus 100, capable of reducing image blur, may be implemented using the plurality of light source bars LB1 to LB4.

Meanwhile, as illustrated in FIG. 3B, the first IR receiving device IRrb1 and the second IR receiving device IRra may be disposed between a first light source bar LB1, among the plurality of light source bars LB1 to LB4, and the center Axis of the rotation plate RB.

While FIG. 3B illustrates an example in which a distance between the first IR receiving device IRrb1 and the center Axis of the circular rotation plate RB is r1, and a distance between the second IR receiving device IRra and the center Axis of the circular rotation plate RB is r2 which is smaller than r1. Accordingly, it is possible to separately receive an IR signal for fixing the screen position and an IR signal for indicating the start of the image.

Meanwhile, unlike FIG. 3B, the distance between the first IR receiving device IRrb1 and the center Axis of the circular rotation plate RB may also be smaller than the distance between the second IR receiving device IRra and the center Axis of the circular rotation plate RB.

Meanwhile, the plurality of first IR receiving devices IRrb1 to IRrb8 are disposed on the rotation plate RB, and the plurality of first IR receiving devices IRrb1 to IRrb8 are spaced apart from the center Axis of the circular rotation plate RB by an equal distance r1. Accordingly, the IR signal for fixing the screen position may be identified frequently.

Meanwhile, referring to FIG. 3C, the rotation plate RB is disposed on top of the fixing plate FB, and particularly, the first IR output device IRtb and the second IR output device IRta are disposed on an upper surface of the fixed plate FB, and the first IR receiving device IRrb1 and the second IR receiving device IRra may be disposed on a rear surface of the rotation plate RB at positions corresponding to the first IR output device IRtb and the second IR output device IRta.

Accordingly, it is possible to separately receive the IR signal for fixing the screen position and the IR signal for indicating the start of the image.

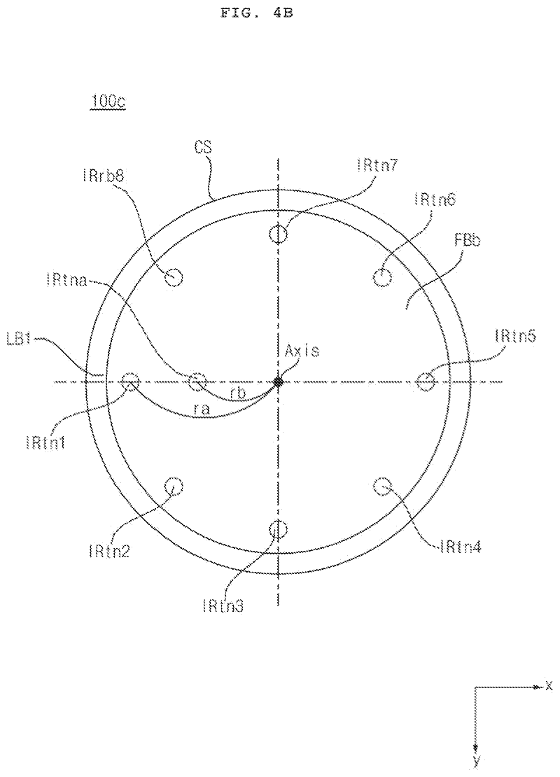

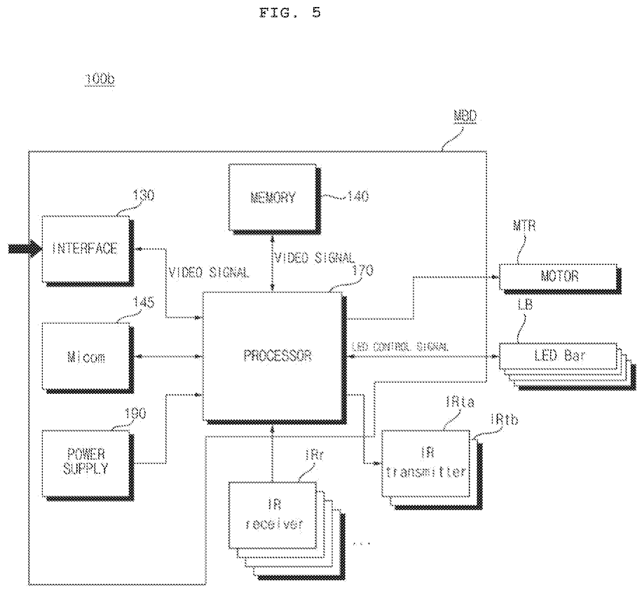

FIGS. 4A and 4B are diagrams illustrating a display apparatus according to yet another embodiment of the present disclosure.

FIG. 4A is a diagram illustrating an outer appearance of a display apparatus 100c according to yet another embodiment of the present disclosure, FIG. 4B is an exemplary cross-sectional view of the fixed plate FBb of FIG. 4A.

The display apparatus 100c of FIG. 4A is similar to the display apparatus 100b of FIG. 3A, but is different in that a plurality of first IR output devices IRtn1 to IRtn8 are used instead of one first IR output device IRtb, and one first IR receiving device IRtnb is used instead of the plurality of first IR receiving devices.

Referring the display apparatus 100c according to yet another embodiment of the present disclosure includes a case CS, a motor MTR disposed in the case CS, a rotation plate RBb rotated by the motor MTR, a plurality of light source bars LB1 to LB4 disposed on the rotation plate RBb and including a plurality of light sources LD1 to LDn that are vertically arranged, a fixed plate FBb spaced below the rotation plate RBb, a first IR receiving device IRrnb and a second IR receiving device IRrna that are disposed on the rotation plate RBb and are spaced apart from each other, and a plurality of first IR output devices IRtn1 to IRtn8 and a second IR output device IRtna that are disposed on the fixed plate FBb and are configured to output respective IR signals.

Accordingly, the display apparatus 100, capable of reducing image blur during image display based on an afterimage, may be implemented. In addition, the display apparatus 100 may be implemented in which points represented by the respective pixels in an image are not blurred during image display based on an afterimage.

Meanwhile, as illustrated in FIG. 4B, the plurality of first IR output devices IRtn1 to IRtn8 are disposed on the fixed plate FBb, and the plurality of first IR output devices IRtn1 to IRtn8 may be equally spaced apart from the center Axis of the circular rotation plate RB.

Meanwhile, the IR signals respectively output from the plurality of first IR output devices IRtn1 to IRtn8 may be received by the first IR receiving device IRrnb.

Meanwhile, the IR signal output from the one second IR output device IRtna may be received by the second IR receiving device IRrna.

In FIG. 4B, an example is illustrated in which a distance between the first IR output device IRtn1 and the center Axis of the circular fixed plate FBb is ra, and a distance between the second IR output device IRtna and the center Axis of the circular fixed plate FBb is rb which is smaller than ra. Accordingly, it is possible to separately receive the IR signal for fixing the screen position and the IR signal for indicating the start of the image.

Meanwhile, a case UCS, which is a portion of the case CS corresponding to an upper portion of the rotation plate RBb, may include a transparent material, and a case DCS, which is a portion of the case CS corresponding to a lower portion of the rotation plate RBb, may include an opaque material. Accordingly, an image may be displayed only in a region where the plurality of light sources LD1 to LDn are disposed, and an image is not displayed in a region where the plurality of light sources LD1 to LDn are not disposed.

FIG. 5 is an exemplary internal block diagram of the display apparatus of FIG. 3A.

Referring to the drawing, the display apparatus 100b according to an embodiment of the present disclosure may include a main board MBD for driving the plurality of light source bars LB1 to LB4.

Of an upper surface and a rear surface of the circular rotation plate RB of FIG. 3A, the main board MBD may be disposed on the rear surface.

The main board MBD in the display apparatus 100B according to an embodiment of the present disclosure may include an interface 130, a memory 140, a microcomputer (Micom) 145, a processor 170, and a power supply 190.

The interface 130 may receive a video signal from an external electronic device or a network, etc., through wired communication or wireless communication.

The video signal received by the interface 130 may be transmitted to the processor 170.

The memory 140 may store programs for processing and control operations of the processor 170, and may also store a signal-processed image, audio, or data signal.

The Micom 145 may receive a remote control signal, an input signal, or the like from an external source, and may transmit the received remote control signal or input signal, or the like to the processor 170.

Upon receiving the remote control signal, the input signal, or the like from an external source, the Micom 145 may control the processor 170, operating in a stand-by mode, to operate in an active mode.

The processor 170 may perform signal processing on the video signal through the interface 130, and may output a control signal for driving a plurality of light sources in the plurality of light source bars LB1 to LB4.

Meanwhile, the processor 170 may perform various signal processing operations. To this end, the processor 170 may be implemented in the form of a System-On-Chip (SOC) including an FPGA.

Besides, the processor 170 may control the overall operation of the display apparatus 100b.

The power supply 190 may supply operation power throughout the entire display apparatus 100b.

Particularly, the power supply 190 may supply power to the processor 170 which may be implemented as a System On Chip (SOC), the plurality of light source bars LB1 to LB4 for image display, an audio output device (not shown) for audio output, and the like.

Specifically, the power supply 190 may include a DC/DC converter configured to receive DC power from an external source by a slip ring or a wireless power transmission method, and to convert a level of the received DC power.

Meanwhile, the processor 170 may control the motor MTR and may control the motor MTR to rotate at a constant speed during image display.

For example, in the case where a second processor (not shown) for controlling the motor MTR is disposed on the fixed plate FB, the processor 170 may transmit a signal to the second processor (not shown) through wired or wireless communication, to control the motor MTR to rotate at a constant speed.

Meanwhile, the processor 170 may control the motor MTR, and may control the motor MTR to rotate at a first speed while displaying an image of a first resolution, and may control the motor MTR to rotate at a second speed, higher than the first speed, while displaying an image of a second resolution higher than the first resolution.

Meanwhile, the processor 170 may control the operation of the IR output devices IRta and IRtb.

Meanwhile, the processor 170 may control a turn-on period of the plurality of light sources LD1 to LDn based on the IR signal received by the IR receiving device IRr.

For example, the processor 170 may perform counting on the IR signals, received by the first IR receiving device IRrb1 and the second IR receiving device IRra, based on an internal clock, and may generate each pixel location signal based on a counted value, so as to output light corresponding to a pixel value.

Specifically, the processor 170 may detect a change in rotational speed of the motor MTR based on the IR signals received by the first IR receiving device IRrb1 and the second IR receiving device IRra, and may change the turn-on period of the plurality of light sources LD1 to LDn in response to the change in rotational speed of the motor MTR.

Accordingly, the display apparatus 100b, capable of reducing image blur caused by a change in speed of the motor MTR during image display based on an afterimage, may be implemented.

Meanwhile, in response to detecting the change in rotational speed of the motor MTR while displaying a first image frame, the processor 170 may change the turn-on period of the plurality of light sources LD1 to LDn based on the change in rotational speed of the motor MTR, while displaying a second image frame after the first image frame. Accordingly, the display apparatus 100b, capable of reducing image blur caused by a change in speed of the motor MTR during image display based on an afterimage, may be implemented.

Meanwhile, in response to an increase in rotational speed of the motor MTR, the processor 170 may decrease the turn-on period of the plurality of light sources LD1 to LDn, and in response to a decrease in rotational speed of the motor MTR, the processor 170 may increase the turn-on period of the plurality of light sources LD1 to LDn. Accordingly, the display apparatus 100b, capable of reducing image blur caused by a change in speed of the motor MTR during image display based on an afterimage, may be implemented.

Meanwhile, a processor 170 may generate a pixel location signal and a start signal of an image frame based on the infrared signals received by the first IR receiving device IRrb1 and the second IR output device IRra. Accordingly, the rotatable display apparatus 100b may be implemented in which points represented by the respective pixels in an image are not blurred during image display based on an afterimage.

Meanwhile, the processor 170 may display an image frame, including a pixel signal, based on the infrared signals received by the first IR receiving device IRrb1 and the second IR output device IRra. Accordingly, the display apparatus 100, capable of reducing image blur during image display based on an afterimage, may be implemented.

Meanwhile, the processor 170 may measure a change in speed of the motor MTR based on the IR signals received by the first IR receiving device IRrb1 and the second IR receiving device IRra during a first image frame period, and may be configured to display an image, corresponding to the measured change in speed of the motor MTR, during a second image frame period after the first image frame period. Accordingly, the display apparatus 100, capable of reducing image blur caused by a change in speed of the motor MTR during image display based on an afterimage, may be implemented.

Meanwhile, the processor 170 may predict a maximum speed error during rotation of the motor MTR based on the IR signals received by the first IR receiving device IRrb1 and the second IR receiving device IRra. Further, the number of the first IR receiving devices may be determined based on the maximum speed error. Accordingly, the rotatable display apparatus, capable of reducing image blur caused by a change in speed of the motor MTR during image display based on an afterimage, may be implemented. Particularly, the rotatable display apparatus including an optimal number of first IR receiving devices, which is selected based on a modeling method, may be implemented.

Meanwhile, the operation of the processor 170 of FIG. 5 may also be applied to the display apparatus 100c of FIG. 4A.

However, the processor 170 in the display apparatus 100c of FIG. 4A may control the turn-on period of the plurality of light sources LD1 to LDn based on the IR signals received by the plurality of first IR receiving devices IRrb1 to IRrb8.

For example, the processor 170 in the display apparatus 100c of FIG. 4A may perform counting on the IR signals, received by the plurality of first IR receiving devices IRrb1 to IRrb8 and the second IR receiving device IRrna, based on an internal clock, and may generate a pixel location signal based on a counted value, so as to output light corresponding to a pixel value.

Specifically, the processor 170 in the display apparatus 100c of FIG. 4A may detect a change in rotational speed of the motor MTR based on the IR signals received by the plurality of first IR receiving devices IRrb1 to IRrb8 and the second IR receiving device IRrna, and may change the turn-on period of the plurality of light sources LD1 to LDn in response to the change in rotational speed of the motor MTR.

Accordingly, the display apparatus 100b, capable of reducing image blur caused by a change in speed of the motor MTR during image display based on an afterimage, may be implemented.

Meanwhile, upon detecting the change in rotational speed of the motor MTR when displaying a first image frame, the processor 170 in the display apparatus 100c of FIG. 4A may change the turn-on period of the plurality of light sources LD1 to LDn in response to the change in rotational speed of the motor MTR, when displaying a second image frame after the first image frame. Accordingly, the rotatable display apparatus 100c, capable of reducing image blur caused by a change in speed of the motor MTR during image display based on an afterimage, may be implemented.

Meanwhile, in response to an increase in rotational speed of the motor MTR, the processor 170 in the display apparatus 100c of FIG. 4A may decrease the turn-on period of the plurality of light sources LD1 to LDn, and in response to a decrease in rotational speed of the motor MTR, the processor 170 may increase the turn-on period of the plurality of light sources LD1 to LDn. Accordingly, the rotatable display apparatus 100c, capable of reducing image blur caused by a change in speed of the motor MTR during image display based on an afterimage, may be implemented.

Meanwhile, the processor 170 in the display apparatus 100c of FIG. 4A may generate a pixel location signal and a start signal of an image frame based on the infrared signals received by the plurality of first IR receiving devices IRrb1 to IRrb8 and the second IR receiving device IRrna. Accordingly, the rotatable display apparatus 100c may be implemented in which points represented by the respective pixels in an image are not blurred during image display based on an afterimage.

Meanwhile, the processor 170 may be configured to display an image frame, including a pixel signal, based on the plurality of first IR receiving devices IRrb1 to IRrb8 and the second IR receiving device IRrna. Accordingly, the rotatable display apparatus 100c, capable of reducing image blur during image display based on an afterimage, may be implemented.

Meanwhile, the processor 170 in the display apparatus 100c of FIG. 4A may measure a change in speed of the motor MTR based on the IR signals received by the plurality of first IR receiving devices IRrb1 to IRrb8 and the second IR receiving device IRrna during a first image frame period, and may be configured to display an image, corresponding to the measured change in speed of the motor MTR, during a second image frame period after the first image frame period. Accordingly, the rotatable display apparatus, capable of reducing image blur caused by a change in speed of the motor MTR during image display based on an afterimage, may be implemented.

Meanwhile, the processor 170 in the display apparatus 100c of FIG. 4A may predict a maximum speed error during rotation of the motor MTR based on the IR signals received by the plurality of first IR receiving devices IRrb1 to IRrb8 and the second IR receiving device IRrna. Further, the number of the first IR receiving devices may be determined based on the maximum speed error.

Accordingly, the rotatable display apparatus, capable of reducing image blur caused by a change in speed of the motor MTR during image display based on an afterimage, may be implemented.

Particularly, the rotatable display apparatus may be implemented using an optimal number of first IR receiving devices.

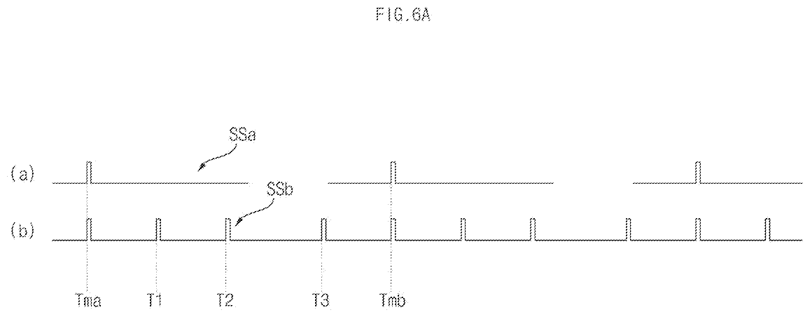

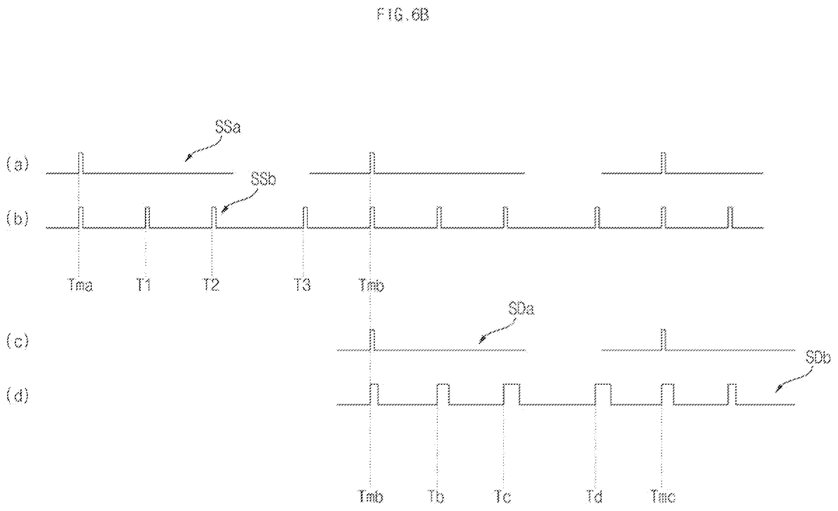

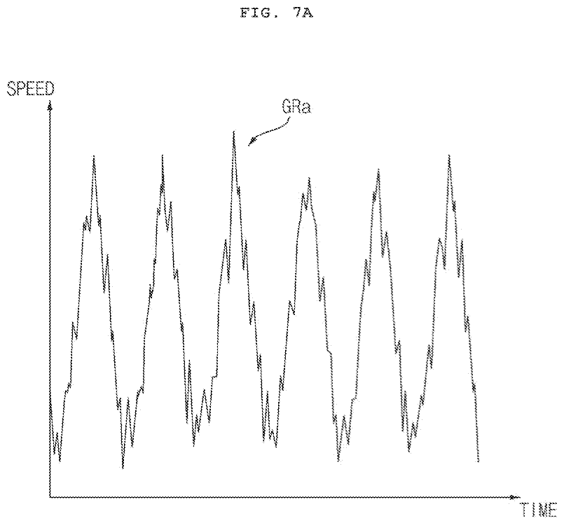

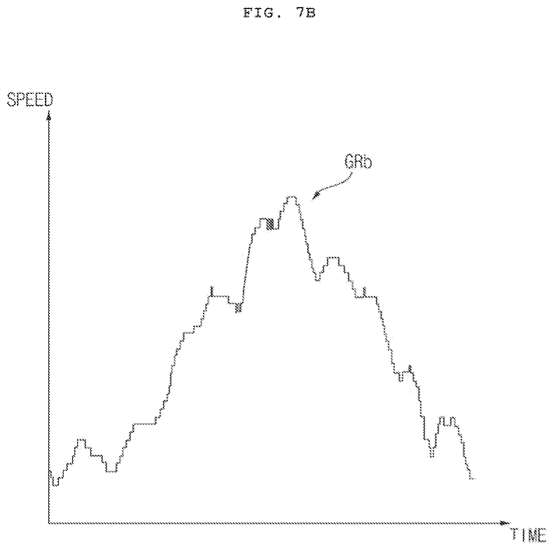

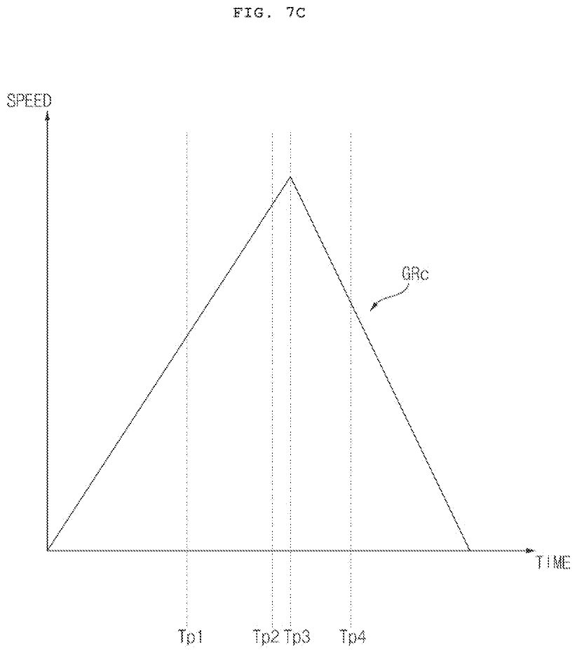

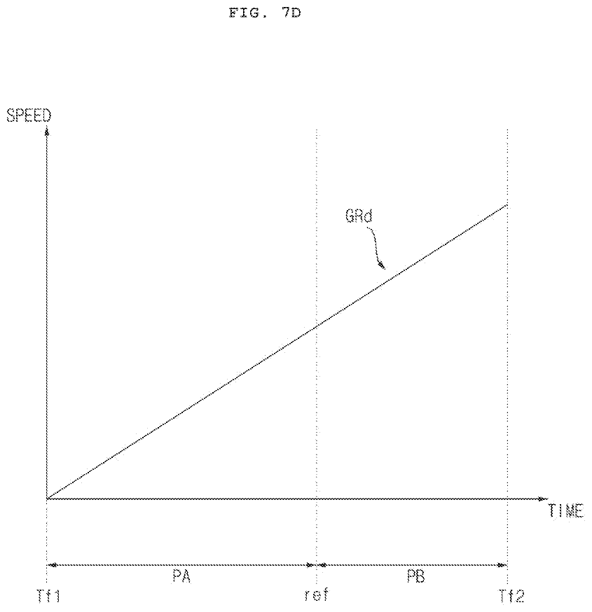

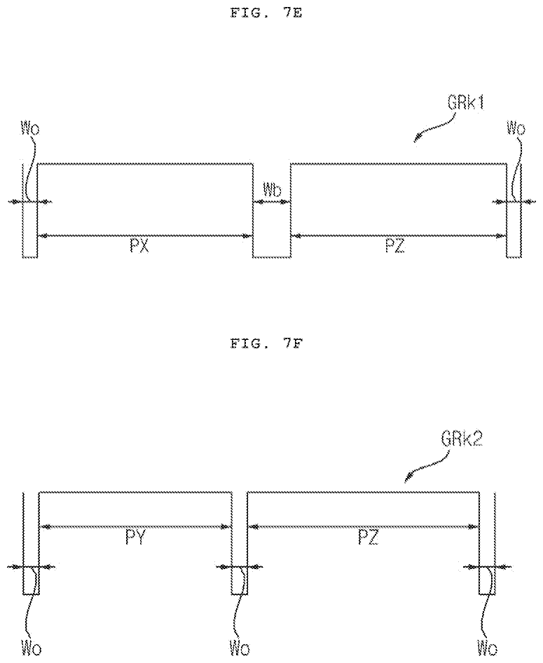

FIGS. 6A and 7F are diagrams referred to in the description of the display apparatuses of FIGS. 2A to 5.

First, FIG. 6A is a diagram illustrating an IR signal SSb received by a plurality of first IR receiving devices and an IR signal SSa received by a second IR receiving device.

In the case where four first IR receiving devices IRrb1 to IRrb4 are disposed instead of the eight first IR receiving devices IRrb1 to IRrb8 of FIG. 3A, the IR signal SSb as illustrated in (b) of FIG. 6A may be input to the processor 170.

If an image frame starts at time Tma, the second IR output device IRta outputs an infrared ray, such that the IR signal SSa received by the second IR receiving device IRra may have a high level.

Then, if a subsequent image frame starts at time Tmb, the second IR output device IRta outputs an infrared ray, such that the IR signal SSa received by the second IR receiving device IRra may have a high level. Meanwhile, the level of the IR signal between times Tma and Tmb may be a low level.

Meanwhile, the first IR output device IRtb may output four infrared rays for four first IR receiving devices IRrb1 to IRrb4 during one rotation of the motor MTR.

In response thereto, the first IR receiving device IRrb1 receives a high-level infrared signal SSb at time Tma, the second IR receiving device IRrb2 receives a high-level infrared signal SSb at time T1, a third IR receiving device IRrb3 receives a high-level infrared signal SSb at time T2, and a fourth IR receiving device IRrb4 receives a high-level infrared signal SSb at time T3.

Meanwhile, in the case where the four first IR receiving devices IRrb1 to IRrb4 are spaced at equal intervals with the same reception interval, if a rotational speed is constant during one rotation of the motor MTR, an interval between Tma and T1, an interval between T1 and T2, an interval between T2 and T3, and an interval between T3 and Tmb are required to be the same.

However, when the motor MTR is actually driven, a period occurs in which the rotational speed changes during one rotation of the motor MTR.

As a result, the interval between times Tma and T1, the interval between times T1 and T2, the interval between times T2 and T3, and the interval between times T3 and Tmb become different from each other.

Accordingly, the processor 170 may detect a change in rotational speed of the motor MTR based on the IR signals SSb respectively received by the plurality of the first IR receiving devices IRrb1 to IRrb4, and may control a turn-on period of the plurality of light sources LD1 to LDn to change.

Particularly, upon detecting the change in rotational speed of the motor MTR when displaying a first image frame, the processor 170 may change the turn-on period of the plurality of light sources LD1 to LDn in response to the change in rotational speed of the motor MTR, when displaying a second image frame after the first image frame.

FIG. 6B is a diagram illustrating a vertical sync signal SDa of a second image frame after a first image frame, and a turn-on signal SDb of the plurality of light sources LD1 to LDn.

Referring to the drawing, (a) of FIG. 6B shows an IR signal SSa received by the second IR receiving device, (b) of FIG. 6B shows an IR signal SSb received by the plurality of first IR receiving devices IRrb1 to IRrb4, (c) of FIG. 6B shows the vertical sync signal SDa of the second image frame after the first image frame, and (d) of FIG. 6B shows the turn-on signal SDb of the plurality of light sources LD1 to LDn.

Meanwhile, if an interval between times T2 and T3 is greater than an interval between times T1 and T2 as illustrated in the drawing, the speed of the motor MTR between times T2 and T3 is lower than the speed of the motor MTR between times T1 and T2.

In order to compensate for the difference, the processor 170 may control a turn-on period between times Tc and Td, corresponding to a period between times T2 and T3, to increase more than a turn-on period between times Tb and Tc corresponding to a period between times T1 and T2. Accordingly, the rotatable display apparatus 100, capable of reducing image blur caused by a change in speed of the motor MTR during image display based on an afterimage, may be implemented.

Meanwhile, a period between times Tmb and Tmc in the drawing refers to a period for displaying the second image frame, and may correspond to a period of the first image frame between times Tma and Tmb.

For example, in the case where the processor 170 is required to display 1920 pixels in a rotation direction, if four IR receiving devices IRrb1 to IRrb4 are used, the processor 170 may generate 480 pixel location signals based on the received IR signal SSb.

In another example, in the case where the processor 170 is required to display 1920 pixels in a rotation direction, if eight IR receiving devices IRrb1 to IRrb8 are used, the processor 170 may generate 240 pixel location signals based on the received IR signal.

In yet another example, in the case where the processor 170 is required to display 1280 pixels in a rotation direction, if four IR receiving devices IRrb1 to IRrb4 are used, the processor 170 may generate 320 pixel location signals based on the received IR signal SSb.

In further another example, in the case where the processor 170 is required to display 1280 pixels in a rotation direction, if eight IR receiving devices IRrb1 to IRrb8 are used, the processor 170 may generate 160 pixel location signals based on the received IR signal.

Meanwhile, in order to further generate a turn-on signal SDb of the plurality of light sources LD1 to LDn, the processor 170 may generate additional signals representing pixels between the IR signals SSb received by the plurality of first IR receiving devices IRrb1 to IRrb4.

For example, in the case where four IR signals SSb are received by the plurality of first IR receiving devices IRrb1 to IRrb4, the processor 170 may generate 480 additional signals in an interval between the IR signals SSb.

Meanwhile, as illustrated in (c) of FIG. 6B, the processor 170 may generate a vertical sync signal based on the IR signal SDa received by the second IR receiving device IRra.

That is, the vertical sync signal may be generated from the IR signal SDa for fixing a start position.

Meanwhile, as illustrated in (d) of FIG. 6B, the processor 170 may generate 480 additional signals in a subsequent period by counting a time of a previous period by using four received IR signals SDb.

For example, the processor 170 may apply 480 pixel location signals, generated by counting a time of a Tb-Tc period in (d) of FIG. 6B, to a Tc-Td period. In this manner, the processor 170 may reflect a speed variation trend during image display.

That is, based on an earlier received IR signal, the processor 170 may generate a pixel location signal for a pixel corresponding to a next received IR signal. In this manner, the processor 170 may reflect a speed variation trend during image display.

FIG. 7A is a diagram illustrating a speed waveform GRa of the motor MTR in the case where the motor MTR is driven at a constant speed.

FIG. 7B is an enlarged view of a constant speed period of FIG. 7A in a speed waveform GRb of the motor MTR.

FIG. 7C is a diagram illustrating a graph GRc obtained by modeling the waveform GRb of FIG. 7B.

Referring to the drawings, the speed of the motor MTR is higher at time Tp2 than at time Tp1, and has a peak value at time Tp3. Thereafter, the motor MTR rotates at a lower speed at time Tp4 than at time Tp3.

Meanwhile, times Tp1 to Tp4 in the drawings may correspond to timings at which IR signals are received by four first IR receiving devices IRrb1 to IRrb4.

The processor 170 may identify actual speeds, respectively corresponding to times Tp1 to Tp4, based on the IR signals respectively received by the four first IR receiving devices IRrb1 to IRrb4.

For example, an area relative to a time axis, which is the x-axis in graph GRc, is a distance between the respective first IR receiving devices IRrb1 to IRrb4, such that by using the area, the processor 170 may calculate Tp1, Tp2, Tp3, and Tp4 which are regions with the same distance.

Meanwhile, there is a time difference between interval Tp1-Tp2, which is a previous interval, and a Tp2-Tp3 interval which is a subsequent interval, in which case if the time difference is too large, an image is highly over-represented or under-represented.

If an image is over-represented, pixels may not be represented, and if an image is under-represented, pixel spacing increases as time remains until a next pixel is displayed after one pixel is displayed.

Meanwhile, as the number of the plurality of first IR receiving devices increases, a time error is reduced which occurs when a time of a previous interval is reflected in a subsequent interval.

For example, it is appropriate to use 1920 first IR receiving devices for 1920 pixels, which are difficult to be applied in actual practice in consideration of physical constraints, manufacturing costs, and the like.

Accordingly, it is preferable to use a plurality of first IR receiving devices with less time error and its number being optimal in physical and cost terms.

To this end, the processor 170 may perform modeling based on a performance index of the motor MTR and IR signals received by the first IR receiving device IRrb1 and the second IR receiving device IRra, and may predict a maximum speed error during rotation of the motor MTR based on the modeling.

Further, the number of first IR receiving devices may be determined based on the maximum speed error. Accordingly, an optimal number of first IR receiving devices may be selected in response to the change in speed of the motor MTR.

FIG. 7D is a diagram illustrating an actual speed waveform GRd of the motor MTR in the case where the motor MTR is driven at a constant speed.

Referring to the drawing, the speed waveform GRd of the motor MTR is a modeled waveform, and the processor 170 may determine whether a timing margin is sufficient or insufficient based on interval PA between time Tf1 and a reference time and interval PB between the reference time and time Tf2.

For example, if interval PA is greater than interval PB, the processor 170 may determine that the timing margin is insufficient, and may control a turn-on period of a corresponding light source to increase in order to resolve under-representation of pixels.

In another example, if interval PA is smaller than interval PB, the processor 170 may determine that the timing margin is sufficient, and may control a turn-on period of a corresponding light source to decrease in order to resolve over-representation of pixel.

FIG. 7E is a diagram illustrating an example of a horizontal sync signal GRk1 for driving a plurality of light sources.

Referring to the drawing, in the case where interval PX, which is a high-level interval between a first low-level interval Wo and a second low-level interval Wb of the horizontal sync signal GRk1, is the same as interval PZ which is a high-level interval between the second low-level interval Wb and a third low-level interval Wo, if a width of the second low-level interval Wb is larger than the first low-level interval wo, pixels may be under-represented.

In order such to resolve under-representation of pixel, the processor 170 may control a turn-on period of a corresponding light source to increase.

FIG. 7F is a diagram illustrating another example of a horizontal sync signal GRk2 for driving a plurality of light sources.

Referring to the drawing, in the case where interval PY, which is a high-level interval between a first low-level interval Wo and a second low-level interval Wo of the horizontal sync signal GRk2, is smaller than interval PZ which is a high-level interval between the second low-level interval Wo and a third low-level interval Wo, pixels may be under-represented.

In order to resolve such under-representation of pixel, the processor 170 may control a turn-on period of a corresponding light source to increase.

Although preferred embodiments have been described with reference to the drawings, those skilled in the art will appreciate that various modifications and variations may be made in the embodiments without departing from the spirit or scope of the disclosure described in the appended claims, and such variations of this specification are not to be understood individually from the or separately technical scope or spirit of this specification.

What is claimed is:

1. A display apparatus comprising:
a case;
a motor disposed in the case;
a rotation plate rotated by the motor;
a plurality of light source bars disposed on the rotation plate, and including a plurality of light sources vertically arranged;
a fixed plate spaced below the rotation plate;
a first infrared (IR) output device and a second IR output device disposed on the fixed plate and spaced apart from each other; and
a first IR receiving device and a second IR receiving device disposed on the rotation plate and configured to receive infrared (IR) signals respectively output from the first IR output device and the second IR output device.

2. display apparatus of claim 1, further comprising a processor configured to detect a change in rotational speed of the motor based on the IR signals received by the first IR receiving device and the second IR output device, and in response to the change in rotational speed of the motor, configured to change a turn-on period of the plurality of light sources.

3. The display apparatus of claim 2, wherein in response to detecting the change in rotational speed of the motor while displaying a first image frame, the processor is configured to change the turn-on period of the plurality of light sources based on the change in rotational speed of the motor while displaying a second image frame after the first image frame.

4. The display apparatus of claim 2, wherein in response to an increase in rotational speed of the motor, the processor is configured to decrease the turn-on period of the plurality of light sources, and
wherein in response to a decrease in rotational speed of the motor, the processor is configured to increase the turn-on period of the plurality of light sources.

5. The display apparatus of claim 1, further comprising a processor configured to generate a pixel location signal and a start signal of an image frame based on the IR signals received by the first IR receiving device and the second IR output device.

6. The display apparatus of claim 1, further comprising a processor configured to display an image frame, including a pixel signal, based on the IR signals received by the first IR receiving device and the second IR output device.

7. The display apparatus of claim 1, wherein the plurality of light source bars are equally spaced apart from a center of the rotation plate having a circular shape.

8. The display apparatus of claim 1, wherein the plurality of light source bars are equally spaced apart from the center of the rotation plate having a circular shape,
wherein the first IR receiving device and the second IR receiving device are disposed between a first light source bar, among the plurality of light source bars, and the center of the rotation plate.

9. The display apparatus of claim 1, wherein a plurality of first IR receiving devices are disposed on the rotation plate,
wherein the plurality of first IR receiving devices are equally spaced apart from the center of the rotation plate having a circular shape.

10. The display apparatus of claim 1, wherein a plurality of first IR receiving devices are disposed on the rotation plate,
wherein the plurality of first IR receiving devices are configured to receive the IR signal output from the first IR output device.

11. The display apparatus of claim 1, wherein a plurality of first IR output devices are disposed on the fixed plate,
wherein the plurality of first IR output devices are equally spaced apart from a center of the fixed plate having a circular shape.

12. The display apparatus of claim 1, wherein a plurality of first IR output devices are disposed on the fixed plate,
wherein IR signals respectively output from the plurality of first IR output devices are received by the first IR receiving device.

13. The display apparatus of claim 1, further comprising a processor configured to measure a change in speed of the motor based on the IR signals received by the first IR receiving device and the second IR receiving device during a first image frame period, and to display an image, corresponding to the measured change in speed of the motor, during a second image frame period after the first image frame period.

14. The display apparatus of claim 1, further comprising a processor configured to predict a maximum speed error during rotation of the motor based on the IR signals received by the first IR receiving device and the second IR receiving device,
wherein a number of the first IR receiving devices is determined based on the maximum speed error.

15. The display apparatus of claim 1, wherein a case, which is a portion of the case corresponding to an upper portion of the rotation plate, comprises a transparent material.

16. The display apparatus of claim 15, wherein a case, which is a portion of the case corresponding to a lower portion of the rotation plate, comprises an opaque material.
